(19) United States
(12) Patent Application Publication
(10) Pub. No.: US 2005/0237419 A1
(43) Pub. Date: Oct. 27, 2005

(54) Camera module, holder for use in a camera module, camera system and method of manufacturing a camera module

(75) Inventor: Leonardus Antonius Elisabeth Van Gemert, Nijmegen (NL)

Correspondence Address: PHILIPS INTELLECTUAL PROPERTY & STANDARDS, P.O. BOX 3001, BRIARCLIFF MANOR, NY, 10510, US

(73) Assignee: koninklijke phillips electronics n.v.

(21) Appl. No.: 10/521,258

(22) PCT Filed: Jul. 15, 2003
(86) PCT No.: PCT/IB03/03234

§ 371 Date: Jan. 13, 2005

(30) Foreign Application Priority Data
Jul. 18, 2002 (EP) 02077930.2

(51) Int. Cl. H04N 5/225

(52) U.S. Cl. 348/340

(57) ABSTRACT

The invention relates to a camera module (100). The camera module (100) comprises a holder (102), which is provided with a light-conducting channel (103). Present in said light-conducting channel (103) is a lens (104) having an optical axis (105). Disposed near an end (106) of the light-conducting channel (103) is a solid-state image sensor (107). The image sensor (107) is provided with an image pick-up section (108) that is oriented perpendicularly to the optical axis (105), and aligning means (112) forming part of the holder (102) are present near the end (106) of the light-conducting channel (121) for aligning the image pick-up section (108) with respect to the optical axis (106). In one embodiment of the camera module (100), the holder (102) is substantially rectangular in shape, seen in cross-sectional view in a direction perpendicular to the optical axis (105). The aligning means are formed by an extension (112) of the light-conducting channel (103), which is present near the end of the light-conducting channel (103) and which is provided with an inner surface (114). The lateral surfaces (115) of the solid-state image sensor (107) are placed in abutment with the inner surface (114) substantially without play. This manner of aligning the image pick-up section (108) with respect to the optical axis (105) simplifies the manufacture of the camera module (100).

The invention relates to a camera module comprising a holder provided with a light-conducting channel, within which channel a lens having an optical axis is present, a solid-state image sensor being present near an end of said light-conducting channel, which image sensor comprises an image pick-up section oriented perpendicularly to the optical axis.

The invention also relates to a holder provided with a light-conducting channel intended for use in a camera module, which is arranged for accommodating a lens having an optical axis and which is furthermore arranged for the placement of a solid-state image sensor comprising an image pick-up section near an end of the light-conducting channel.

The invention also relates to a camera system comprising a camera module, which comprises a holder.

The invention furthermore relates to a method of manufacturing a camera module comprising a holder.

Such a camera module is known from European patent application EP-A 1 081 944. The known camera module is suitable for use in a camera system, such as a camera system incorporated in a telephone, in a portable computer or in a digital photo or video camera. With the known camera module, an image pickup module is placed into abutment with the second end of the holder. The image pickup module of the known camera module comprises a substrate. Present on the side of the substrate facing away from the holder, on which an electrically conductive wiring pattern has been formed, is a solid-state image sensor, for example a CCD (Charge Coupled Device) image sensor or a CMOS (Complementary Metal Oxide Semiconductor) image sensor. The solid-state image sensor is electrically connected to further electronics in a camera system of which the camera module forms part by means of electrically conductive connections, for example in the form of bumps of a suitably selected material, such as gold or another electrically conductive material. One side of the solid-state image sensor facing towards the substrate comprises a light-sensitive area arranged for converting incident light into electrical signals.

In one embodiment of the known camera module, the substrate consists of a non-transparent material, for example a metal plate covered with a flexible foil on which said wiring pattern is present, in which plate an aperture is present for transmitting light to the light-sensitive area of the solid-state image sensor. In another embodiment, the substrate consists of a light-transmitting material, such as glass, on which a conductive wiring pattern is present on the side facing towards the solid-state image sensor.

One drawback of the known camera module is the fact that it requires a complicated manufacturing method, which renders the camera module relatively costly.

It is an object of the invention to provide a camera module designed to enable simple manufacture. This object is achieved with a camera module according to the introductory paragraph, which is characterized in that aligning means forming part of the holder are present near the end of the light-conducting channel, which aligning means align the image pick-up section with respect to the optical axis.

In the camera module according to the invention, the position of the solid-state image sensor in the holder is fixed by the aligning means. Thus the position of the image pick-up section with respect to the optical axis is fixed as well. During manufacture it suffices, therefore, to place the solid-state image sensor in the holder, using the aligning means, in order to align the image pick-up section with respect to the optical axis. This results in a simplification of the manufacture of the camera module.

Furthermore it can be noted that the solid-state image sensor of the camera module according to the invention is not accommodated in an image pickup module, as is the case with the known camera module. Instead, the solid-state image sensor can be placed directly in the holder. This in itself already results in a simplification of the manufacture of the camera module. An additional result is that a reduction of the dimensions of the camera module is obtained, in particular in a direction parallel to the optical axis. This is an advantage, too, since the amount of available space is very limited in many applications in which the camera module is used, and in all probability it will be reduced even further in future applications.

One embodiment of the camera module according to the invention is characterized in that the image pick-up section extends in a plane parallel to a main surface of the solid-state image sensor, in which the solid-state image sensor comprises lateral surfaces oriented at least substantially perpendicularly to the main surface, and in which the holder is at least substantially polygonal near the end, seen in cross-sectional view in a direction perpendicular to the optical axis, in which the aligning means comprise an extension of the holder, which extension extends beyond the end of the light-conducting channel and which has an inner surface that abuts against at least one of the lateral surfaces of the solid-state image sensor, as a result of which the solid-state image sensor is contained within the holder substantially without play in a direction perpendicular to the optical axis.

Since the extension having said inner surface ensures that substantially no play remains between the inner surface and the lateral surfaces of the solid-state image sensor, the position of the solid-state image sensor and thus the position of the image pick-up section is fixed in a plane perpendicular to the optical axis of the lens. Thus it suffices to position the solid-state image sensor at the inner surface of the extension, with the main surface extending perpendicularly to the optical axis and facing towards the lens, to align the image pick-up section with respect to the optical axis. This leads to a further simplification of the manufacture of the camera module as regards the alignment of the image pick-up section with respect to the optical axis.

Another embodiment of the camera module according to the invention is characterized in that the end of the light-conducting channel is provided with an abutting surface oriented perpendicularly to the optical axis, against which abutting surface the main surface of the solid-state image sensor abuts substantially without play, thereby determining the distance from the image pick-up section to the lens.

When the extension is configured in this way, it will be easier to fit the solid-state image sensor within the inner surface of the extension. This leads to a further simplification of the manufacture of the camera module as regards the alignment of the image pick-up section with respect to the optical axis.

Another embodiment of the camera module according to the invention is characterized in that the end of the light-conducting channel is provided with an abutting surface oriented perpendicularly to the optical axis, against which the main surface of the solid-state image sensor abuts substantially without play, thereby determining the distance from the image pick-up section to the lens.

Once the solid-state image sensor is mounted in the holder, the main surface of the solid-state image sensor extends parallel to the abutting surface against which it abuts. As a result, the image pick-up section of the solid-state image sensor extends parallel to the abutting surface, too. The abutting surface is oriented perpendicularly to the optical axis. Thus it is achieved that the image pick-up section will be oriented perpendicularly to the optical axis after the solid-state image sensor has been placed. This orientation leads to an improved quality of the images being projected onto the image pick-up section by the lens in use. This leads to a further simplification of the manufacture of the camera module.

In this way it is furthermore achieved that the image pick-up section can be positioned a predetermined distance away from the lens. If the tolerances in the dimensions of the lens and the barrel are sufficiently small, it may no longer be necessary to focus the lens upon placement of the lens. Generally, focusing is a time-consuming step that must be carried out with due precision. Thus, a simplification of the manufacture of the camera module can be achieved by leaving out this step.

Another embodiment of the camera module according to the invention is characterized in that the holder is provided with pins whose longitudinal axis extends parallel to the optical axis, which pins are fixed to said second end, with the pins being located in openings in the substrate, thereby aligning the camera module with respect to the substrate.

The use of the pins and the corresponding openings in the substrate simplifies the positioning of the holder on the substrate upon assembly of the camera module or a camera system of which the camera module forms part. This simplifies the manufacture of a camera system. Furthermore, the use of the pins and the corresponding openings in the substrate makes it possible to strengthen the connection between the holder and the substrate.

Another embodiment of the camera module according to the invention is characterized in that the main surface of the solid-state image sensor extends outside the light-conducting channel, with pads being provided on the part of the main surface outside the light-conducting channel, which pads function to provide electrical connections to electric circuits located outside the solid-state image sensor.

When the solid-state image sensor is configured in this manner, and all the pads are placed near one of the lateral surfaces and provided with bumps, it will be easy to electrically contact the solid-state image sensor by means of a flex foil tape provided with a conductive wiring pattern and thus electrically connect the camera module to other electronics in a camera system. This obviates the need to connect integrated circuits present on the solid-state image sensor to conductive wiring patterns on a substrate by means of bond wires. The provision of bond wires is a relatively time-consuming step, which needs to be carried out with due precision.

Another embodiment of the camera module according to the invention is characterized in that an outer wall of the holder is provided with at least one supporting wall, which extends parallel to the optical axis and which abuts against one of the lateral surfaces of the solid-state image sensor insofar as it extends outside the light-conducting channel.

Said supporting wall screens a connection, via said bumps, between a flex foil tape and the pads on the solid-state image sensor via the bumps. This makes it easier, for example, to handle the camera module upon assembly of a camera system of which the camera module forms part. The fact is that it is less necessary to take the vulnerability of the connection between the tape and the solid-state image sensor into account.

A holder according to the invention for use in a camera module, which is provided with a light-conducting channel which is arranged for accommodating a lens having an optical axis and which is furthermore arranged for the placement of a solid-state image sensor comprising an image pick-up section near an end of the light-conducting channel is characterized in that aligning means forming part of the holder are present near said end of the light-conducting channel for aligning the image pick-up section with respect to the optical axis.

In the holder according to the invention, the position at which the solid-state image sensor comprising the image pick-up section is to be placed is fixed by the aligning means. Thus, the position of the image pick-up section with respect to the optical axis is fixed as well. Upon manufacture of the camera module it thus suffices to place the solid-state image sensor in the holder, using the aligning means, in order to align the image pick-up section with respect to the optical axis. Consequently, the manufacture of the camera module is simplified by using the holder according to the invention when manufacturing the camera module.

A camera system according to the invention comprises a camera module comprising a holder provided with a light-conducting channel in which a lens having an optical axis is present, in which a solid-state image sensor provided with an image pick-up section oriented perpendicularly to the optical axis is present near an end of the light-conducting channel, and in which aligning means forming part of the holder are present near said end of the light-conducting channel for aligning the image pick-up section with respect to the optical axis.

The camera system according to the invention employs a camera module in which the position of the solid-state image sensor in the holder is fixed by the aligning means. Thus, the position of the image pick-up section with respect to the optical axis is fixed as well. During manufacture it suffices, therefore, to place the solid-state image sensor in the holder, using the aligning means, in order to align the image pick-up section with respect to the optical axis. This results in a simplification of the manufacture of the camera system.

A method of manufacturing a camera module comprising a holder is characterized in that the holder is provided with aligning means, in which the solid-state image sensor comes into contact with the aligning means upon placement of the solid-state image sensor in said holder, as a result of which an image pick-up section present on the solid-state image sensor is aligned with respect to an optical axis.

During manufacture, a lens having an optical axis is placed in the holder. For a correct operation of the camera module it is important that the solid-state image sensor is aligned with respect to the optical axis in a plane perpendicular to the optical axis. In order to achieve this, the camera module is provided with aligning means upon manufacture. Automatic alignment of the image pick-up section with respect to the optical axis is achieved by placing the solid-state image sensor into contact with the aligning means upon placement of the solid-state image sensor in the holder. This results in a simplification of the manufacture of the camera system.

These and other aspects of the invention will now be discussed in more detail with reference to the drawings, in which:

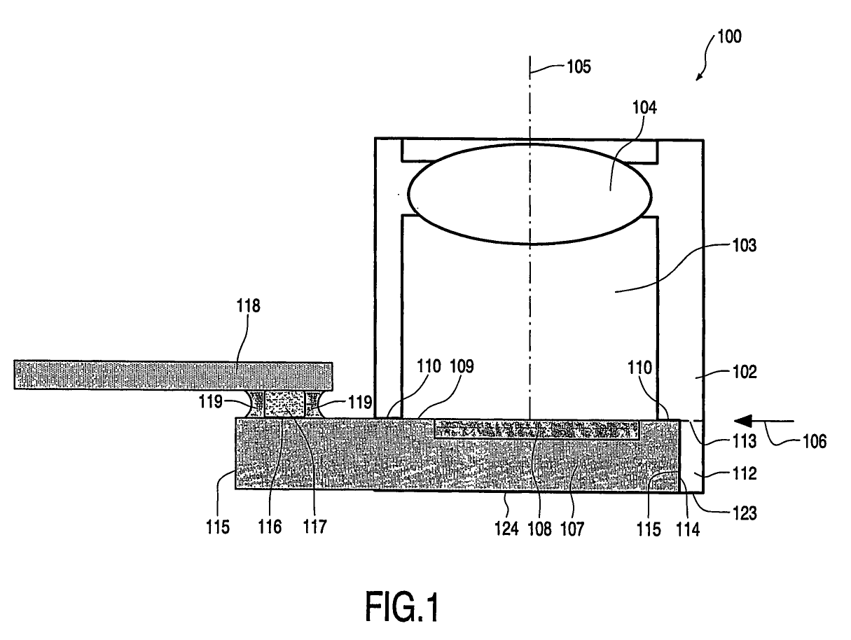

FIG. 1 is a longitudinal sectional view of the camera module according to the invention;

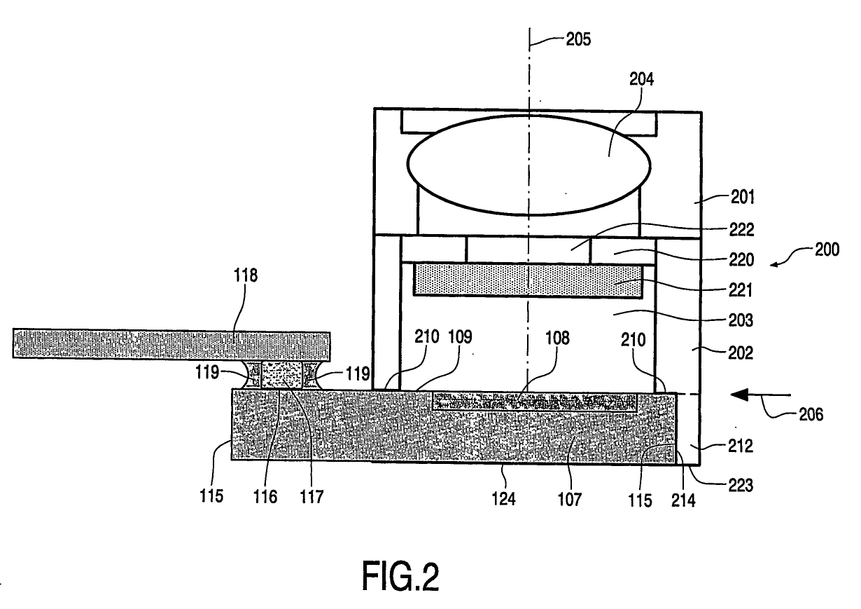

FIG. 2 is a longitudinal sectional view of a second embodiment of the camera module according to the invention;

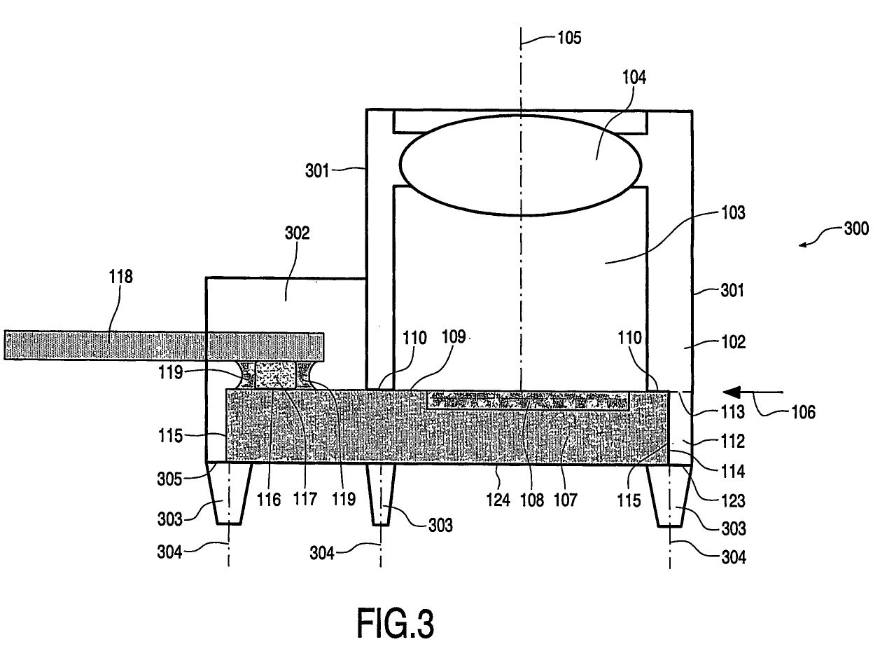

FIG. 3 is a longitudinal sectional view of a third embodiment of the camera module according to the invention; and

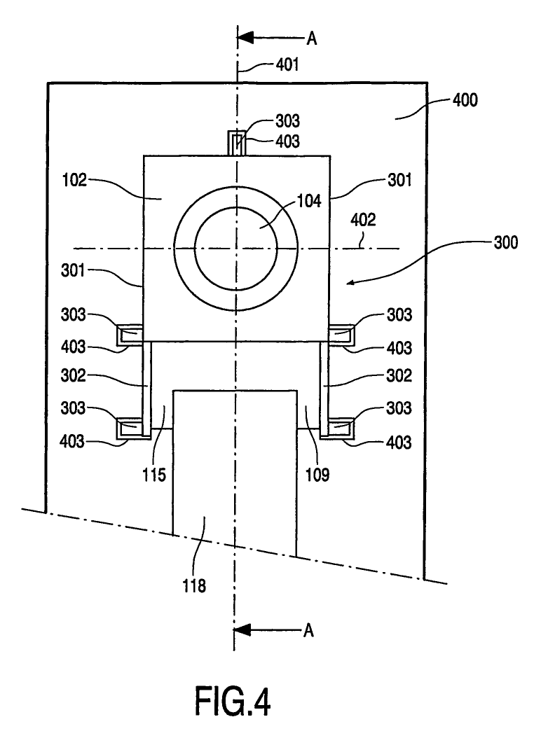

FIG. 4 is a plan view of the third embodiment of the camera module according to the invention.

In the figures, like parts are indicated by the same numerals.

FIG. 1 shows a longitudinal sectional view of an embodiment of the camera module according to the invention. The camera module 100 comprises a holder 102 provided with a light-conducting channel 103. Present within the light-conducting channel 103 is a lens 104 having an optical axis 105. A solid-state image sensor 107 comprising an image pick-up section 108 is present near an end of the light-conducting channel, as indicated by the arrow 106. The image pick-up section 108 is oriented perpendicularly to the optical axis 105.

The image pick-up section 108 extends parallel to a main surface 109 of the solid-state image sensor 107 that faces towards the lens 104. In addition to that, the solid-state image sensor 107 has lateral surfaces 115 that extend perpendicularly to the main surface 109. The end of the light-conducting channel is provided with an abutting surface 110 which is oriented perpendicularly to the optical axis 105. The main surface 109 of the solid-state image sensor 107 abuts against the abutting surface 110 substantially without play. This achieves that the image pick-up section 108 will be oriented perpendicularly to the optical axis 105 upon manufacture of the camera module 100. The advantage of the perpendicular orientation of the image pick-up section 108 with respect to the optical axis 105 is that the image pick-up section 108 will be positioned more precisely in the focus of the lens 104, which will result in a greater sharpness of the images being projected onto the image pick-up section 108 by the lens 104. Another result achieved by the abutment of the main surface 109 of the solid-state image sensor against the abutting surface 110 is that the distance from the image pick-up section 108 to the lens 104 is determined. If the lens 104 is mounted sufficiently precisely in the light-conducting channel 103, this has the advantage that no further focusing of the lens with respect to the image pick-up section 108 will be needed upon manufacture of the camera module 100. This leads to a simplification of the manufacture of the camera module 100.

The holder 102 is rectangular in shape, seen in cross-sectional view perpendicular to the optical axis 105, near the end of the light-conducting channel 103. An extension 112 being in line with the light-conducting channel 103 is present at the end of said light-conducting channel 103. In FIG. 1, a broken line 113 indicates the location of the transition between the holder 102 and the extension 112 by way of illustration. Although it is possible to manufacture the holder 102 and the extension 112 as separate parts and subsequently join the two, the extension 112 will generally be formed in one piece with the holder 102 for the sake of simplicity. The extension 112 has an inner surface 114, which is configured to abut three of the lateral surfaces 115 of the solid-state image sensor 107. This achieves that the lateral surfaces 115 will abut against the inner surface 114 of the extension 112 substantially without play after placement of the solid-state image sensor 107. As a result, the image pick-up section 108 of the solid-state image sensor 107 will be aligned with the optical axis 105 simply through the placement of the solid-state image sensor 107. This means a simplification of the manufacture of the camera module 100, because the number of operations required for aligning the image pick-up section 108 with respect to the optical axis 105 is reduced. The position of the solid-state image sensor 107 is fixed in a usual manner, for example by means of a glue that is usually used for this purpose.

As FIG. 1 shows, the solid-state image sensor extends partially beyond the holder 102. The part of the main surface 109 that extends beyond the holder 102 is provided with pads 116 near one of the lateral surfaces 115. The pads 116 are connected, via bumps 117, to a pattern of conductive tracks arranged on a flex foil tape 118. In this way the integrated circuits present on the solid-state image sensor 107 can be electrically connected to further electronic circuits present in a camera system. Said electronic circuits for example function to arrange the supply of voltage to the integrated circuits, for example via a battery or a mains adapter, and the reading and further processing of the signals generated by the solid-state image sensor. An underfill material 119 is provided round the bumps for the purpose of strengthening the mechanical connection between the tape 118 and the solid-state image sensor 107, which material bonds the side of the tape 118 that faces towards the main surface 109 and the main surface 109 together.

The extension 112 has a second end 123, which extends in a plane perpendicular to the optical axis 105. The solid-state image sensor 107 has a second main surface 124, which lies substantially in one plane with the second end 123. Upon mounting of the camera module 100 in a camera system, the camera module 100 can be fixed to a substrate in a usual manner, for example by means of a suitable glue, via said second main surface 124 and said second end.

FIG. 2 shows a longitudinal sectional view of a second embodiment of the camera module according to the invention. The camera module 200 comprises a barrel 201, which is mounted on a holder 202 provided with a light-conducting channel 203. Present within the barrel 201 is a lens 204 having an optical axis 205. Furthermore present within the light-conducting channel is a diaphragm 220 comprising an opening 222 perpendicular to the optical axis 205. An infrared filter 221 extending over the opening 222 abuts the diaphragm 220. It is generally advisable to use an infrared filter 221, because the solid-state image sensors are usually made of silicon. Such solid-state image sensors are much more sensitive to radiation in the infrared part of the electromagnetic spectrum than to visible light. Corrections for this are made by means of the infrared filter 221.

Present near an end of the light-conducting channel, as indicated by the arrow 206, is a solid-state image sensor 107 comprising an image pick-up section 108. The image pick-up section 108 is oriented perpendicularly to the optical axis 205.

The image pick-up section 108 extends parallel to a main surface 109 of the solid-state image sensor 107 that faces towards the lens 104. In addition to that, the solid-state image sensor 107 comprises lateral surfaces 115 oriented perpendicularly to the main surface 109. The end of the light-conducting channel 203 is provided with an abutting surface 210 which is oriented perpendicularly to the optical axis 205. The main surface 109 of the solid-state image sensor 107 abuts against the abutting surface 210 substantially without play. This achieves that the image pick-up section 108 will be oriented perpendicularly to the optical axis 205 upon manufacture of the camera module 200. The advantage of the perpendicular orientation of the image pick-up section 108 with respect to the optical axis 205 is that the image pick-up section 108 will be positioned more precisely in the focus of the lens 204, which will result in a greater sharpness of the images being projected onto the image pick-up section 108 by the lens 204. Another result achieved by abutment of the main surface 109 of the solid-state image sensor against the abutting surface 210 is that the distance from the image pick-up section 108 to the lens 204 is determined. If the lens 204 is mounted sufficiently precisely in the light-conducting channel 203, this has the advantage that no further focusing of the lens with respect to the image pick-up section 108 will be needed upon manufacture of the camera module 200. This leads to a simplification of the manufacture of the camera module 200.

The holder 202 is rectangular in shape, seen in cross-sectional view perpendicular to the optical axis 205, near the end of the light-conducting channel 203. An extension 212 being in line with the light-conducting channel 203 is present at the end of said light-conducting channel 203. In FIG. 1, a broken line 213 indicates the location of the transition between the holder 202 and the extension 212 by way of illustration. Although it is possible to manufacture the holder 202 and the extension 212 as separate parts and subsequently join the two, the extension 212 will generally be formed in one piece with the holder 202 for the sake of simplicity. The extension 212 has an inner surface 214, which is configured to abut three of the lateral surfaces 115 of the solid-state image sensor 107. This achieves that the lateral surfaces 115 will abut against the inner surface 214 of the extension 212 substantially without play after placement of the solid-state image sensor 107. As a result, the image pick-up section 108 of the solid-state image sensor 107 will be aligned with the optical axis 205 simply through the placement of the solid-state image sensor 107. This means a simplification of the manufacture of the camera module 200, because the number of operations required for aligning the image pick-up section 108 with respect to the optical axis 205 is reduced. The position of the solid-state image sensor 107 is fixed in a usual manner, for example by means of a glue that is usually used for this purpose.

As FIG. 2 shows, the solid-state image sensor extends partially beyond the holder 202. The part of the main surface 209 that extends beyond the holder 202 is provided with pads 116 near one of the lateral surfaces 115. The pads 116 are connected, via bumps 117, to a pattern of conductive tracks arranged on a flex foil tape 118. In this way the integrated circuits present on the solid-state image sensor 107 can be electrically connected to further electronic circuits present in a camera system. Said electronic circuits for example function to arrange the supply of voltage to the integrated circuits, for example via a battery or a mains adapter, and the reading and further processing of the signals generated by the solid-state image sensor. An underfill material 119 is provided round the bumps for the purpose of strengthening the mechanical connection between the tape 118 and the solid-state image sensor 107, which material bonds the side of the tape 118 that faces towards the main surface 109 and the main surface 109 together.

The extension 212 has a second end 223, which extends in a plane perpendicular to the optical axis 205. The solid-state image sensor 107 has a second main surface 224, which lies substantially in one plane with the second end 223. Upon mounting of the camera module 200 in a camera system, the camera module 200 can be fixed to a substrate in a usual manner, for example by means of a suitable glue, via said second main surface 224 and said second end.

FIG. 3 shows a longitudinal sectional view of a third embodiment of the camera module according to the invention. Besides the elements that have been discussed with reference to FIG. 1, the camera module 300 also comprises an outer wall 301, to which a supporting wall 302 is attached. The supporting wall 302 extends in a plane parallel to the optical axis 105 and abuts against the lateral surfaces 115 that extend partially outside the holder 102. The supporting wall 302 functions to protect the connection of the tape 118 to the solid-state image sensor 102. This facilitates the handling of the camera module after assembly thereof, for example during transport or upon mounting of the camera module in a camera system.

The extension 112 and the supporting wall 302 are provided with pins 303, each having a longitudinal axis 304 oriented parallel to the optical axis 105. The pins are fixed to the second end 123 of the extension and to a third end 305 of the supporting wall 302, respectively, said second end 123 and said third end 302 lying in one plane oriented perpendicularly to the optical axis 105. The pins 303 may be used for aligning the camera module on a substrate upon mounting of the camera module in a camera system, if said substrate is provided with holes corresponding to the pins 303. The pins 303 may be slightly tapered, so that the precision with which the pins 303 are aligned with respect to the corresponding holes in the substrate plays less important a part when mounting the camera module 300.

FIG. 4 is a plan view of the third embodiment of the camera module according to the invention. The plane AA′ indicates the plane of the longitudinal sectional view of FIG. 3. The camera module 300 is connected to a substrate 400. The substrate is provided with holes 403, into which the pins 303 extend. In the illustrated embodiment, the shape of the holes 403 conforms to the rectangular shape of the pins 303. In actual practice, the holes 403 will generally be boreholes, which means that they will be circular in shape. In that case it will be more practical to adapt the shape of the pins 303 to conform to said shape.

Fixed to the main surface 109, near one of the lateral surfaces 115 of the solid-state image sensor 107, is the tape 118. The supporting walls 302 abut against the two opposed lateral surfaces 115 that extend partially outside the holder 102. The walls 302 are attached to the outer wall 30 one of the holder 102. The pins 303 are fixed to the outer wall 301 and to the supporting walls 302. The optical axis 105 of the lens 104 present within the holder 102 is represented by the intersection of the lines 410 and 412.

Summarizing the above, the invention relates to a camera module 100. The camera module 100 comprises a holder 102, which is provided with a light-conducting channel 103. Present in said light-conducting channel 103 is a lens 104 having an optical axis 105. Disposed near an end 106 of the light-conducting channel 103 is a solid-state image sensor 107, which is provided with an image pick-up section 108 that is oriented perpendicularly to the optical axis 105. Aligning means 112 forming part of the holder 102 are present near the end 106 of the light-conducting channel 121. Said aligning means align the image pick-up section 108 with respect to the optical axis 106. In one embodiment of the camera module 100, the holder 102 is substantially rectangular near the end 106, seen in cross-sectional view in a direction perpendicular to the optical axis 105, and the aligning means are formed by an extension 112 of the light-conducting channel 103, which is present near the end of the light-conducting channel 103 and which is provided with an inner surface 114. The inner surface 114 abuts the lateral surfaces 125 of the solid-state image sensor 107 substantially without play. This manner of aligning the image pick-up section 108 with respect to the optical axis 105 simplifies the manufacture of the camera module 100.

1. A camera module comprising a holder provided with a light-conducting channel, within which channel a lens having an optical axis is present, a solid-state image sensor being present near an end of said light-conducting channel, which image sensor comprises an image pick-up section oriented perpendicularly to the optical axis, characterized in that aligning means forming part of the holder are present near the end of the light-conducting channel, which aligning means align the image pick-up section with respect to the optical axis.

2. A camera module as claimed in claim 1, characterized in that the image pick-up section extends in a plane parallel to a main surface of the solid-state image sensor, in which the solid-state image sensor comprises lateral surfaces oriented at least substantially perpendicularly to the main surface, and in which the holder is at least substantially polygonal near the end, seen in cross-sectional view in a direction perpendicular to the optical axis, in which the aligning means comprise an extension of the holder, which extension extends beyond the end of the light-conducting channel and which has an inner surface that abuts against at least one of the lateral surfaces of the solid-state image sensor, as a result of which the solid-state image sensor is contained within the holder substantially without play in a direction perpendicular to the optical axis.

3. A camera module as claimed in claim 2, characterized in that said polygon is a rectangle.

4. A camera module as claimed in claim 3, characterized in that said extension abuts at least substantially against three of the lateral surfaces of the solid-state image sensor.

5. A camera module as claimed in claim 4, characterized in that the end of the light-conducting channel is provided with an abutting surface oriented perpendicularly to the optical axis, against which the main surface of the solid-state image sensor abuts substantially without play, thereby determining the distance from the image pick-up section to the lens.

6. A camera module as claimed in claim 2, characterized in that the camera module comprises a substrate, that the solid-state image sensor is provided with a second main surface which is oriented perpendicularly to the main surface, that the extension has a second end which coincides at least substantially with the plane in which also the second main surface extends, which second main surface and which second end abut against the substrate.

7. A camera module as claimed in claim 6, characterized in that the holder is provided with pins whose longitudinal axis extends parallel to the optical axis, which pins are fixed to the second end, with the pins being located in openings in the substrate, thereby aligning the camera module with respect to the substrate.

8. A camera module as claimed in claim 2, characterized in that the main surface of the solid-state image sensor extends outside the light-conducting channel, with pads being provided on the part of the main surface outside the light-conducting channel, which pads function to provide electrical connections to electric circuits located outside the solid-state image sensor.

9. A camera module as claimed in claim 8, characterized in that an outer wall of the holder is provided with at least one supporting wall, which extends parallel to the optical axis and which abuts against one of the lateral surfaces of the solid-state image sensor insofar as it extends outside the light-conducting channel.

10. A holder for use in a camera module, which holder is provided with a light-conducting channel, which is arranged for accommodating a lens having an optical axis and which is furthermore arranged for the placement of a solid-state image sensor comprising an image pick-up section near an end of the light-conducting channel, characterized in that aligning means forming part of the holder are present near said end of the light-conducting channel for aligning the image pick-up section with respect to the optical axis.

11. A camera system comprising a camera module with a holder provided with a light-conducting channel in which a lens having an optical axis is present, in which a solid-state image sensor provided with an image pick-up section oriented perpendicularly to the optical axis is present near an end of the light-conducting channel, and in which aligning means forming part of the holder are present near said end of the light-conducting channel for aligning the image pick-up section with respect to the optical axis.

12. A method of manufacturing a camera module comprising a holder, characterized in that the holder is provided with aligning means, in which the solid-state image sensor comes into contact with the aligning means upon placement of the solid-state image sensor in said holder, as a result of which an image pick-up section present on the solid-state image sensor is aligned with respect to an optical axis.
